(19) United States
(12) Patent Application Publication
(10) Pub. No.: US 2006/0015914 A1
(43) Pub. Date: Jan. 19, 2006

(54) Recording method and apparatus capable of time shifting in a plurality of channels

(75) Inventor: Jung-won Lee, Ansan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/150,214

(22) Filed: Jun. 13, 2005

(30) Foreign Application Priority Data
Jul. 16, 2004 (KR) 10-2004-0055478

(51) Int. Cl. H04N 7/173

(52) U.S. Cl. 725/101; 725/97

(57) ABSTRACT

A multi-channel recording method and a multi-channel recording apparatus capable of time-shifting in plurality of channels are provided. The multi-channel recording method includes: selecting a channel among a plurality of time-shift channels; decoding and displaying a transport stream of the selected channel while storing transport streams broadcast on the plurality of time-shift channels; deleting the transport stream of the selected channel when a new channel is selected, decoding and displaying a transport stream of the newly selected channel while storing the transport streams broadcast on the plurality of time-shift channels.

### BACKGROUND OF THE INVENTION

This application claims priority from Korean Patent Application No. 10-2004-0055478, filed on Jul. 16, 2004 in the Korean Intellectual Property Office, the disclosure of which is incorporated herein in its entirety by reference.

1. Field of the Invention

Apparatuses and methods consistent with the present relate to a multi-channel recording, and more particularly, to allowing a viewer to time-shift and watch programs broadcast on a plurality of channels by deleting useless data.

2. Description of the Related Art

With the development of digital technology, a digital broadcasting, which provides multi-channel broadcasting and high quality broadcasting, has replaced analog broadcasting. In addition, a digital television (TV) functions not only as a TV receiver but can be used for various applications such as a web TV and a private video recorder (PVR) or a digital video recorder (DVR).

While a video cassette recorder (VCR) is a device which can record video signals on a magnetic tape, the PVR is a digital device which records information on a hard disk and plays the recorded information. When a channel is selected, the PVR automatically records signals currently broadcast on the channel to a hard disk in a digital fashion and simultaneously plays the signals. Accordingly, a time shift is an important PVR function.

The time shift function allows the stored broadcast signals to be played from the point when the stored broadcast signals were stopped when a user clicks a stop button and then clicks a play button. Then, the program is played at regular intervals while being recorded. The user can watch the currently broadcast program later again, play the program in slow motion, and skip boring parts of the program.

The PVR can record programs that are simultaneously broadcast on several channels. According to the multi-channel recording method, the user can record programs broadcast on other channels at the same time when watching, playing or recording a program broadcast on one channel.

However, a conventional multi-channel recording apparatus does not include a time shift function for a plurality of channels. Thus, if a user intends to time-shift and watch programs broadcast on a plurality of channels, all of the programs should be recorded, thereby using a large amount of hard disk storage.

Even if the time shift function is provided to each channel, the time shift function is applied to each program every time a channel is changed, and a previously watched program should be recorded. Alternatively, even if the time shift function for the plurality of channels is applied, there is a problem of managing data stored in a hard disk because the hard disk capacity is limited.

As described above, the conventional multi-channel recording apparatus does not include a time shift function for a plurality of channels, and even if the time shift function is provided to each channel or the time shift function for a plurality of channels is included, there is limitation of the application of time shift function due to the limited hard disk capacity.

### SUMMARY OF THE INVENTION

The present invention provides a recording method allowing a viewer to time-shift and watch programs broadcast on a plurality of channels by deleting useless data.

The present invention also provides a recording apparatus allowing a viewer to time-shift and watch programs broadcast on a plurality of channels by deleting useless data.

According to an aspect of the present invention, there is provided a multi-channel recording method comprising: selecting a channel among a plurality of time-shift channels; decoding and displaying a transport stream of the selected channel while storing transport streams broadcast on the plurality of time-shift channels; deleting the transport stream of the selected channel when a new channel is selected, decoding and displaying a transport stream of the newly selected channel while storing the transport streams broadcast on the plurality of time-shift channels.

According to another aspect of the present invention, there is provided multi-channel recording apparatus comprising: a channel processing unit generating a transport stream for each of a plurality of channels; a first decoding unit decoding the transport stream of a selected channel selected from the plurality of channels into a video signal; a stream storage unit storing transport streams of a plurality of time-shift channels selected from the plurality of channels; and a control unit deleting a portion of the transport stream of the selected channel stored in the stream storage unit from a storing point when the transport stream was first stored to a changing point when a newly selected channel is selected when the selected channel is one of the plurality of time-shift channels.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a recording apparatus according to an exemplary embodiment of the present invention;

FIG. 2 is a flowchart illustrating a recording method according to another exemplary embodiment of the present invention;

FIGS. 3A through 3D are diagrams illustrating procedures of processing transport streams according to the changing of a viewing channel in the recording method illustrated in FIG. 2; and

FIGS. 4A through 4E are diagrams illustrating procedures of processing transport streams according to the changing of a viewing channel in the recording method illustrated in FIG. 2.

### DETAILED DESCRIPTION OF EXEMPLARY EMBODIMENTS OF THE INVENTION

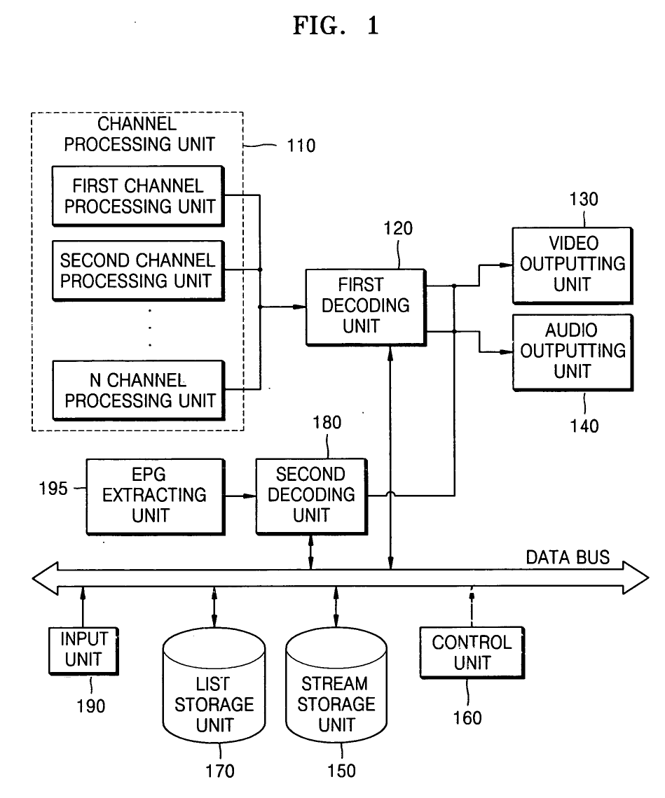

FIG. 1 is a block diagram of a recording apparatus according to an exemplary embodiment of the present invention. Referring to FIG. 1, the recording apparatus includes a channel processing unit 110, a first decoding unit 120, a video outputting unit 130, an audio outputting unit 140, a stream storage unit 150, a control unit 160, a list storage unit 170, a second decoding unit 180, an input unit 190, and an electronic program guide (EPG) extracting unit 195.

The channel processing unit 110 includes a first, second, . . . , Nth channel processors. The channel processing unit 110 classifies received broadcast signals according to channels, and extracts the broadcast signals carried on the channels to generate transport streams for the respective channels.

The first decoding unit 120 receives the transport streams for each channel from the channel processing unit 110. The first decoding unit 120 divides transport stream of a channel selected by a viewer into a video stream and an audio stream. The selected channel is to be viewed by the viewer, and is hereinafter referred to as a “viewing channel”. The first decoding unit 120 decodes the divided video stream into video signals and the audio stream into audio signals.

The video outputting unit 130 receives the video signals from the first decoding unit 120 and outputs the video signals on a screen (not shown), and the audio outputting unit 140 receives audio signals from the first decoding unit 120 and outputs the audio signals through a speaker (not shown).

However, the first decoding unit 120 does not decode the received transport streams of channels to be only recorded, but transmits the streams to the stream storage unit 150. The transport stream of a channel required to be simultaneously played and recorded is decoded in real time by the first decoding unit 120 and transmitted to the stream storage unit 150 at the same time.

The stream storage unit 150 automatically stores the transport streams of the selected plurality of channels, among the transport streams generated by the channel processing unit 110. The selected plurality of channels are to be provided with a time shift function, and are hereinafter referred to as “time shift channels”. The transport streams of the time shift channels are received via the first decoding unit 120. The stream storage unit 150 has enough bandwidth to store several transport streams at the same time.

If the viewing channel is one of the time shift channels, the first decoding unit 120 can decode the transport stream of the viewing channel stored in the stream storage unit 150 and output the decoded stream. Accordingly, a viewer can time-shift and watch the programs broadcast on the time shift channels.

When the viewing channel to be decoded by the first decoding unit 120 is changed from one of the time shift channels to another channel, the control unit 160 deletes the transport stream of the first viewing channel from the stream storage unit 150.

However, as the stream storage unit 150 continuously stores the transport streams broadcast on the time shift channels in real time, the transport stream broadcast on the first viewing channel is continuously stored in the stream storage unit 150 from the point when the viewing channel is changed. Hence, a part of the transport stream to be deleted by the control unit 160 is from the point when the storage of the transport stream of the first viewing channel is started to the point when the viewing channel is changed.

The list storage unit 170 stores information of channel lists. The channel lists are a preference channel list including channels chosen as preference channels, an entire channel list including all of the channels for which the transport streams are generated in the channel processing unit 110, and a history channel list including channels which were previously time shift channels.

The second decoding unit 180 decodes the channel lists information stored in the list storage unit 170 into video and audio signals. The video outputting unit 130 outputs the video signals decoded by the second decoding unit 180 on the screen, and/or the audio outputting unit 140 outputs the audio signals decoded by the second decoding unit 180 through the speaker.

A user selects the time shift channels from the channel lists output by the video outputting unit 130 and the audio outputting unit 140. That is, the user confirms the channel lists output on the screen and/or through the speaker, and selects the time shift channels among the channels included in the channel lists.

The input unit 190 receives a list of the time shift channels selected by the user. The input unit 190 may include an input key or a remote control, or may employ touch screen technology.

The list of the time shift channels input to the input unit 190 is stored in the list storage unit 170 as a history. Accordingly, the history channel list is updated.

The EPG extracting unit 195 extracts EPG information from the broadcast signals. The extracted EPG information is decoded into video signals and audio signals by the second decoding unit 180, and the signals are output by the video outputting unit 130 and/or the audio outputting unit 140.

The user selects the time shift channels based on the EPG information output by the video outputting unit 130 and/or the audio outputting unit 140. The selected time shift channels are input through the input unit 190.

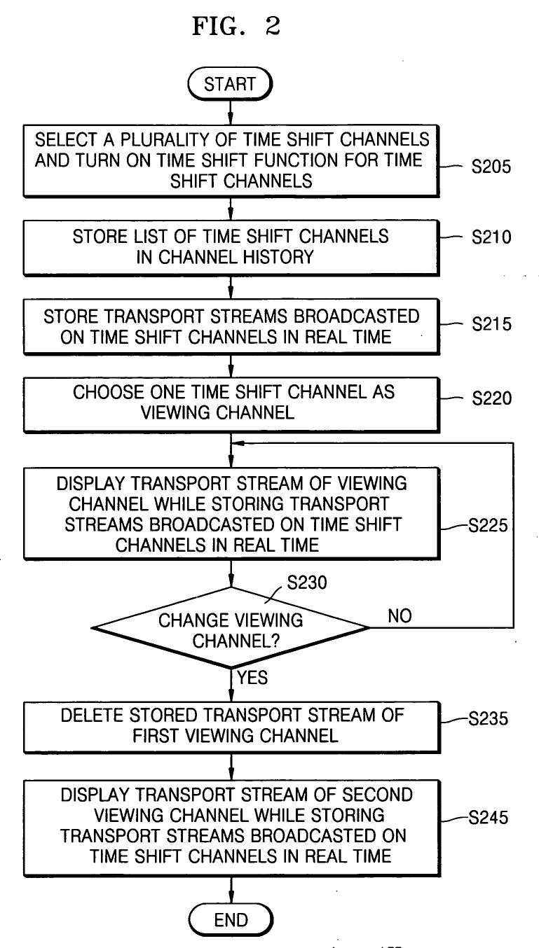

FIG. 2 is a flowchart illustrating a recording method according to an exemplary embodiment of the present invention.

Referring to FIG. 2, a viewer selects a plurality of time shift channels, and turns on a time shift function for each of the selected time shift channels (operation S205).

The viewer selects the time shift channels based on contents of broadcasting programs output on the screen and/or through the speaker by changing viewing channels repeatedly. For example, the viewer can select Channel 7 and views the program broadcast on Channel 7 to determine whether to choose Channel 7 as one of the time shift channels. Afterwards, the viewer can change the channel to Channel 9 and view the program broadcast on Channel 9 to determine whether to choose Channel 9 as one of the time shift channels. Likewise, the viewer changes the channels and views the programs broadcast on the channels, then determines whether to choose the selected viewing channels as the time shift channels.

Alternatively, the viewer selects the time shift channels based on the EPG information output on the screen and/or through the speaker. Specifically, the viewer considers the EPG information displayed on a display, and chooses the channels to be time-shifted.

Otherwise, the viewer selects the time shift channels from the channels included in a predetermined channel list. The predetermined channel list may be the preference channel list, the entire channel list, or the history channel list, which are included in the list storage unit 170. The viewer considers the channel list output on the screen and/or through the speaker, and chooses the channels to be time-shifted from the channels included in the channel list.

The viewer inputs a list of the chosen time shift channels through the input unit 190.

The control unit 160 turns on the time shift function for each of the chosen time shift channels. The viewer can turn on the time shift function for respective time shift channels by clicking a plural channel time-shift button of the input unit 190. The order of clicking the plural channel time-shift button and choosing the time shift channels is not important.

If the viewer clicks the plural channel time-shift button and then chooses the time shift channels, the control unit 160 turns on the time shift function for each of the chosen time shift channels. Here, if the viewer chooses several time shift channels at a time, the control unit 160 turns on the time shift function for the respective time shift channels at once. This may be the case when the viewer selects several time shift channels at the same time using the channel list.

However, if the viewer chooses the time shift channels sequentially, the control unit 160 accordingly turns on the time shift function for each of the time shift channels in order. This may be the case when the viewer selects the viewing channels when repeatedly changing the viewing channels.

If the viewer clicks the plural channel time-shift button after choosing all of the time shift channels, the control unit 160 turns on the time shift function for each of the chosen time shift channels simultaneously.

The list storage unit 170 stores the list of the chosen time shift channels in the channel history (operation S210). Hence, the history channel list is updated.

The stream storage unit 150 stores transport streams broadcast on the time shift channels in real time (operation S215). The transport streams broadcast on the time shift channels are stored in the stream storage 150 via the first decoding unit 120.

When one of the time shift channels is chosen (operation S220) as a viewing channel, the stream storage 150 continues to store the transport streams broadcast on the time shift channels in real time while the first decoding unit 120 decodes a transport stream of the viewing channel and transmits the decoded stream to the video outputting unit 130 and the audio outputting unit 140 (operation S225).

At this point, the first decoding unit 120 decodes the transport stream of the viewing channel received in real time from the channel processing unit 110 and the transport stream of the viewing channel stored in the stream storage unit 150. Accordingly, the viewer can time-shift and watch the program broadcast on the time shifted channel.

If the viewing channel is changed from one of the time shift channels to another channel (operation S230), the control unit deletes a transport stream of the first viewing channel from the stream storage unit 150 (operation S235)

While the stream storage unit 150 stores the transport streams broadcast on the time shift channels in real time, the first decoding unit 120 decodes the transport stream of the second viewing channel and transfers the decoded stream to the video outputting unit 130 and the audio outputting unit 140 (operation S245).

At this point, if the second viewing channel is a time shift channel, the first decoding unit 120 decodes the transport stream of the second viewing channel received in real time from the channel processing unit 110 and the transport stream of the viewing channel stored in the stream storage unit 150. Accordingly, the viewer can time-shift and watch the program broadcast on the viewing channel.

If the second viewing channel is not a time shift channel, the first decoding unit 120 displays the transport stream broadcast on the second viewing channel in real time. Thus, after changing the viewing channel, the viewer cannot time-shift and watch the program broadcast on the viewing channel as long as there is not a transport stream additionally stored in the stream storage unit 150.

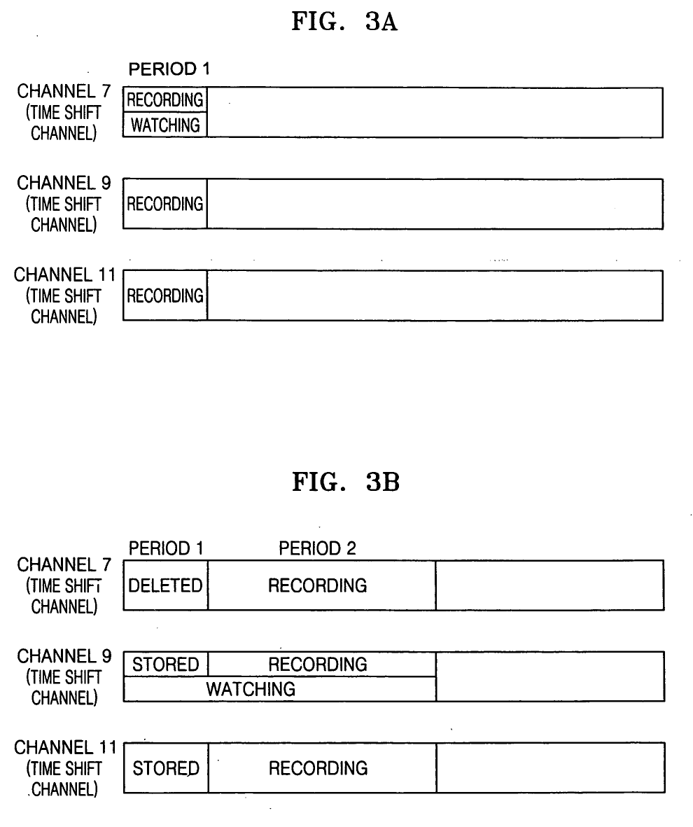

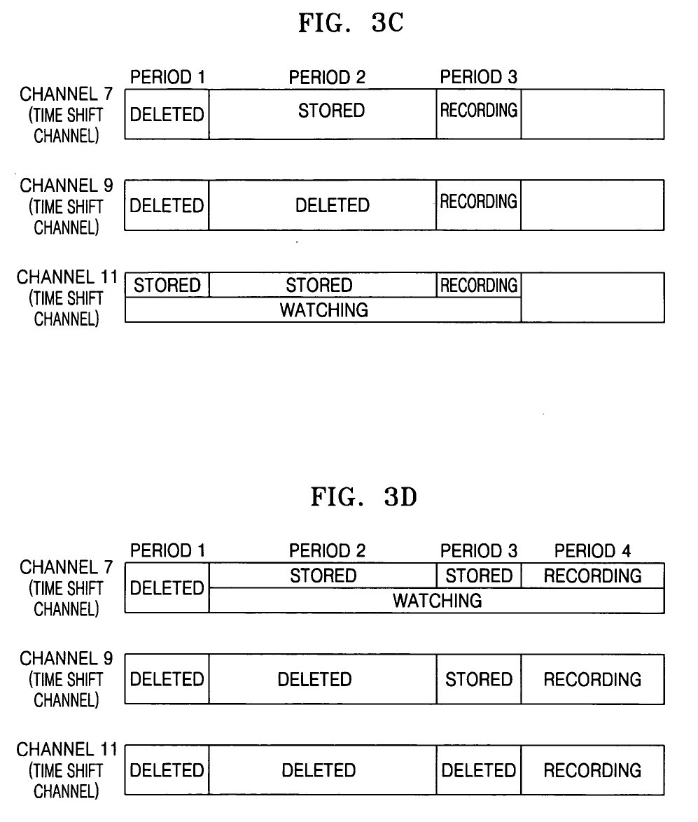

FIGS. 3A through 3D are diagrams illustrating a procedure of processing transport streams according to the changing of the viewing channels in the recording method illustrated in FIG. 2, when the first and second viewing channels are time shift channels.

A case when the viewer selects Channels 7, 9 and 11 as the time shift channels is described.

FIG. 3A is a diagram illustrating when a viewing channel is Channel 7. Referring to FIG. 3A, all of the programs broadcast on Channels 7, 9, and 11 are recorded in real time during a period 1. The viewer time-shifts and watches the program broadcast on Channel 7 during the period 1.

FIG. 3B is a diagram illustrating when the viewing channel is changed to Channel 9 from Channel 7. Referring to FIG. 3B, a portion of the Channel 7 stored during the period 1 is deleted. Then, all of the programs broadcast on Channels 7, 9, and 11 are recorded in real time during a period 2. The viewer time-shifts and watches the program broadcast on Channel 9 and recorded during the periods 1 and 2.

FIG. 3C is a diagram illustrating when the viewing channel is changed to Channel 11 from Channel 9. Referring to FIG. 3C, a portion of the transport stream of Channel 9 stored during the periods 1 and 2 is deleted. Then, all of the programs broadcast on Channels 7, 9, and 11 are recorded in real time during a period 3. The viewer time-shifts and watches the program broadcast on Channel 11 and recorded during the periods 1, 2 and 3.

FIG. 3D is a diagram illustrating when the viewing channel is changed to Channel 7 from Channel 11. Referring to FIG. 3D, a portion the transport stream of Channel 11 stored during periods 1, 2 and 3 is deleted. Then, all of the programs broadcast on Channels 7, 9, and 11 are recorded in real time during a period 4. The viewer time-shifts and watches the program broadcast on Channel 7 and recorded during the periods 2, 3 and 4.

The periods 1 through 4 in FIGS. 3A through 3D are designated according to the arbitrary change of the viewing channel, but are not designated according to the programs.

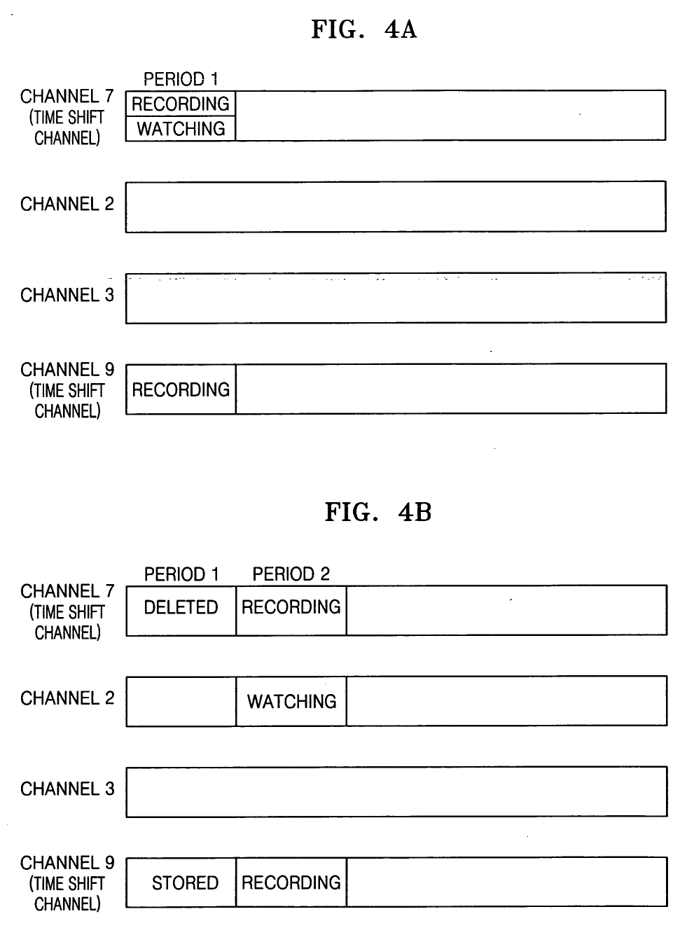

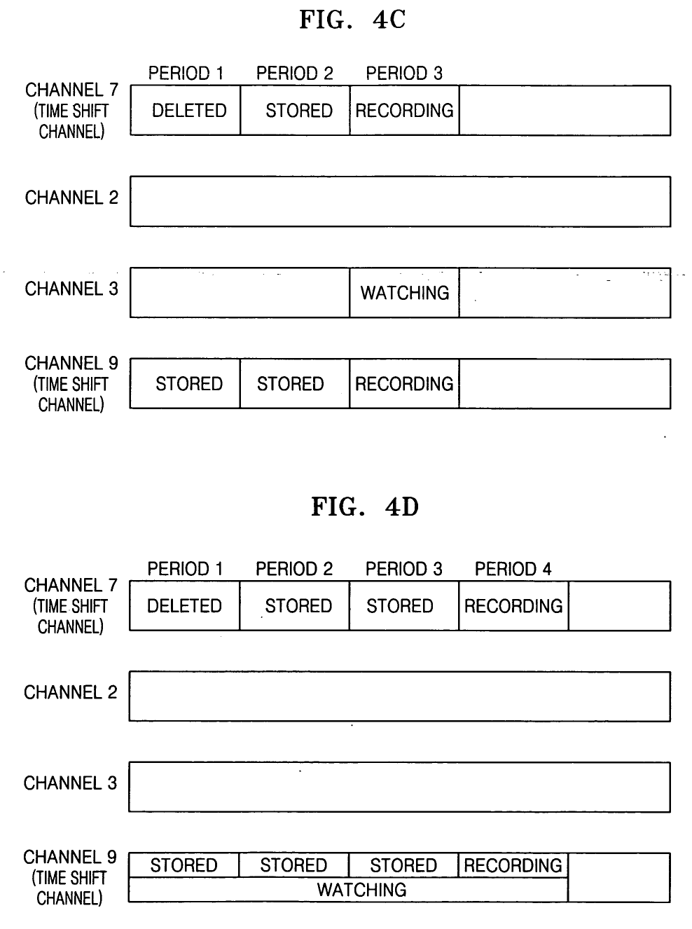

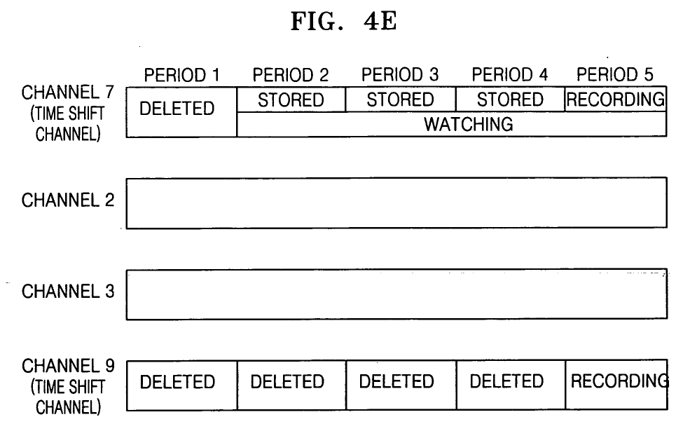

FIGS. 4A through 4E are diagrams illustrating a procedure of processing transport streams according to the change of the viewing channel in the recording method shown in FIG. 2 when the viewing channel is changed to another time shift channel or a non-time shift channel.

A case when the viewer selects channels 7 and 9 as time shift channels is described.

FIG. 4A is a diagram illustrating when the viewing channel is Channel 7. Referring to FIG. 4A, all of the programs broadcast on Channels 7 and 9 are recorded in real time in a section 1. The viewer time-shifts and watches the program broadcast on Channel 7 during a period 1.

FIG. 4B is a diagram when the viewing channel is changed to Channel 2 from Channel 7. Referring to FIG. 4A, a portion of the transport stream of Channel 7 recorded during the period 1 is deleted. Then, all of the programs broadcast on Channels 7 and 9 are recorded in real time during a period 2. The viewer watches the program broadcast on Channel 2 in real time.

FIG. 4C is a diagram illustrating when the viewing channel is changed to Channel 3 from Channel 2. Referring to FIG. 4C, since Channel 2 is not a time shift channel, the transport stream on Channel 2 is not deleted. All of the programs broadcast on Channels 7 and 9 are recorded in real time during the period 3. The viewer watches the program broadcast on Channel 3 in real time.

FIG. 4D is a diagram illustrating when the viewing channel is changed to Channel 9 from Channel 3. Referring to FIG. 4D, since Channel 3 is not a time shift channel, the transport stream on Channel 3 is not deleted. All of the programs broadcast on Channels 7 and 9 are recorded in real time in a section 4. The viewer time-shifts and watches the program broadcast on Channel 9 and recorded during the periods 1 through 4.

FIG. 4E is a diagram illustrating when the viewing channel is changed to Channel 7 from Channel 9. Referring to FIG. 4E, a portion of the transport stream of Channel 9 recorded during the periods 1 through 4 is deleted. During period 5, all of the programs broadcast on Channels 7 and 9 are recorded in real time. The viewer time-shifts and watches the program broadcast on Channel 7 recorded during the periods 2 through 5.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, a PVR can simultaneously record programs broadcast on a plurality of channels using a limited storage effectively by deleting useless data. Thus, a viewer can time-shift, and watch programs broadcast on the selected plurality of channels.

In addition, a plural channel time shift function is implemented by clicking a plural channel time-shift button and selecting a plurality of channels without a complicated input by a user or complicated operations.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multi-channel recording method comprising:
selecting a channel among a plurality of time-shift channels;
decoding and displaying a transport stream of the channel which is selected while storing transport streams broadcast on the plurality of time-shift channels; and
deleting the transport stream of the channel which is selected if a new channel is selected, and decoding and displaying a transport stream of the new channel while storing the transport streams broadcast on the plurality of time-shift channels.

2. The multi-channel recording method of claim 1, wherein the decoding and displaying of the transport stream of the selected channel further includes decoding and displaying a stored transport stream of the channel which is selected.

3. The multi-channel recording method of claim 1, wherein the decoding and displaying of the transport stream of the new channel further includes decoding and displaying a stored transport stream of the new channel when the new channel is one of the plurality of time-shift channels.

4. The multi-channel recording method of claim 1, wherein the plurality of time-shift channels are selected from a plurality of channels.

5. The multi-channel recording method of claim 4, wherein the plurality of time-shift channels are selected on based on one of contents of a displayed broadcast program, displayed electronic program guide (EPG) information and predetermined channel list information.

6. The multi-channel recording method of claim 5, wherein the predetermined channel list information relates to a predetermined channel list which is one of a preference channel list composed of channels designated as preference channels, an entire channel list composed of all received channels and a channel history including channels previously selected as the plurality of channels.

7. A multi-channel recording apparatus comprising:
a channel processing unit which generates a transport stream for each of a plurality of channels;
a first decoding unit which decodes the transport stream of a selected channel which is selected from the plurality of channels into a video signal;
a stream storage unit which stores transport streams of a plurality of time-shift channels selected from the plurality of channels; and
a control unit which deletes a portion of a transport stream of the selected channel stored in the stream storage unit from a storing point if the transport stream was first stored to a changing point when a newly selected channel is selected and the selected channel is one of the plurality of time-shift channels.

8. The multi-channel recording apparatus of claim 7, wherein the first decoding unit decodes the transport stream of the selected channel stored in the stream storage unit if the selected channel is one of the plurality of time-shift channels.

9. The multi-channel recording apparatus of claim 7, further comprising:
a list storage unit which stores channel list information related to a channel list which is at least one of a preference channel list composed of channels designated as preference channels, an entire channel list composed of all channels for which transport streams are generated in the channel processing unit and a channel history composed of channels previously selected as the plurality of time-shift channels;
a second decoding unit which decodes the channel list information stored in the list storage unit into video signals;
a video outputting unit which displays the video signals decoded by the second decoding unit; and
an input unit which receives a list of the plurality of time-shift channels based on the channel list information displayed on the video outputting unit.

10. The multi-channel recording apparatus of claim 7, further comprising:
an electronic program guide (EPG) extracting unit which extracts EPG information from a broadcast signal;
a second decoding unit which decodes the EPG information extracted by the EPG extracting unit into a video signal;
a video outputting unit which displays the video signal decoded by the second decoding unit; and
an input unit which receives a list of the plurality of time-shift channels based on the EPG information displayed on the video outputting unit.
